(19) United States
(12) Patent Application Publication
(10) Pub. No.: US 2011/0019776 A1
(43) Pub. Date: Jan. 27, 2011

(54) METHOD AND APPARATUS FOR OBTAINING PORT INDEX INFORMATION

(75) Inventors: Guodong Zhang, Syosset, NY (US); Afshin Haghighat, lle-Bizard (CA); David S. Bass, Great Neck, NY (US); Erdem Bala, Farmingdale, NY (US)

Correspondence Address: VOLPE AND KOENIG, P.C.;DEPT. ICC, UNITED PLAZA, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/841,276

(22) Filed: Jul. 22, 2010

Related U.S. Application Data
(60) Provisional application No. 61/228,350, filed on Jul. 24, 2009.
(60) Provisional application No. 61/233,914, filed on Aug. 14, 2009.
(60) Provisional application No. 61/248,008, filed on Oct. 2, 2009.

(51) Int. Cl. H04L 27/06

(52) U.S. Cl. 375/340

(57) ABSTRACT

A method and apparatus are described for obtaining port index information. In one scenario, downlink (DL) control information (DCI) is received that includes new data indicator (NDI). The NDI has a value indicating an antenna port for single-port transmission. In response to receiving the DCI, a single-port transmission associated with the indicated antenna port is received. The NDI may be associated with a disabled codeword and the DCI may include a second NDI. The DCI may be received over a physical downlink control channel (PDCCH). The DCI may include a resource block (RB) assignment information field (IF), a hybrid automatic repeat request (HARQ) process identity (ID) IF, a transmit power control (TPC) IF and, for each of a plurality of transport blocks, a modulation and coding scheme (MCS), an NDI and a redundancy version (RV).

### CROSS REFERENCE TO RELATED APPLICATIONS

This application claims the benefit of U.S. Provisional Application No. 61/228,350 filed Jul. 24, 2009, U.S. Provisional Application No. 61/233,914 filed Aug. 14, 2009, and U.S. Provisional Application No. 61/248,008 filed Oct. 2, 2009, which are incorporated by reference as if fully set forth.

### TECHNICAL FIELD

This application is related to wireless communications.

### BACKGROUND

In order to support higher data rate and spectrum efficiency, the Third Generation Partnership Project (3GPP) long term evolution (LTE) system has been introduced into 3GPP. The LTE downlink (DL) transmission scheme is based on an orthogonal frequency division multiple access (OFDMA) air interface. For the LTE uplink (UL) direction, single-carrier (SC) transmission based on discrete Fourier transform (DFT) spread OFDMA (DFT-S-OFDMA) may be used. The use of SC transmission in the UL may be motivated by the lower peak-to-average power ratio (PAPR), (or cubic metric), compared to multi-carrier transmission such as orthogonal frequency division multiplexing (OFDM).

FIG. 1 illustrates the mapping of a transport block 10 to a single LTE carrier 20 in a release 8 (R8) LTE system, for UL or DL transmission. Layer 1 (L1) 30 receives information from a hybrid automatic repeat request (HARQ) entity 40 and a scheduler 50, and uses it to assign a transport block 10 to the LTE carrier 20. As shown in FIG. 1, a UL or DL LTE carrier 20, or simply a carrier 20, is made up of multiple sub-carriers 60. An evolved Node-B (eNodeB) may receive a composite UL signal across the entire transmission bandwidth from one or more WTRUs at the same time, where each WTRU transmits on a subset of the available transmission bandwidth or sub-carriers.

In the LTE DL direction, a wireless transmit/receive unit (WTRU) may be allocated by an eNodeB to receive its data anywhere across the entire LTE transmission bandwidth with allocations that are not necessarily contiguous. An OFDMA scheme is used where non-contiguous groups of sub-carriers may be allocated to a WTRU in a particular sub-frame. The LTE DL may have an unused direct current (DC) offset sub-carrier in the center of the spectrum.

LTE may include various DL transmission modes, one of which (mode 7) is used for single layer beamforming. In this mode, the WTRU may use WTRU-specific reference signals (RSs) defining transmit (Tx) antenna port 5 to demodulate the received data. The eNodeB uses one of two DL control information (DCI) formats for DL grants to the WTRU (DCI format 1 and 1A). DCI format 1 may be used for data using beamforming. This DCI may use resource allocation types 0 and 1. DCI format 1A may be used to allow data to be sent using Tx diversity, rather than beamforming. This DCI may use resource allocation type 2.

LTE also includes a multi-user multiple-input multiple-output (MU-MIMO) mode (mode 5). In this mode, the WTRU still may use the common reference signals (CRS), (Tx ports 0 to 3), for demodulation. The eNodeB may use one of two DCI formats for DL grants to the WTRU (DCI format 1D and 1A). DCI format 1D may be used for MU-MIMO data. This DCI may use resource allocation types 0 and 1, and also may include precoding and power offset information. DCI format 1A may be used to allow a fallback to Tx diversity, as described above.

Dynamic indication of a demodulation reference signal (DMRS) port may be supported in the case of a rank-1 transmission to enable scheduling of two WTRUs with rank-1 transmission using different orthogonal DMRS ports on the same physical DL shared channel (PDSCH) resources. No explicit signaling of the presence of a co-scheduled WTRU may occur in the case of a rank-1 transmission for single-user (SU)-MIMO or MU-MIMO.

In order to improve beamforming and MU-MIMO operation, (both of which are limited to rank-1 transmission), in LTE, dual-layer beamforming and associated MU-MIMO have been proposed. The WTRU may make use of WTRU-specific RSs to define Tx antenna ports (port A and port B). Signaling (DCI formats) for this mode has not yet been defined. Future development of LTE (i.e., advanced LTE (LTE-A)) may support up to eight layers of beamforming.

Although schemes have been proposed and discussed for dual-layer beamforming, detailed DL control signaling is needed to signal the WTRU information about dynamic switching between the different transmission schemes, (rank-1 or rank-2 beamforming, transmit diversity), and the parameters of the transmission scheme being used. The parameters of the transmission scheme include which antenna ports are used in DL transmission and, in some situations of MU-MIMO, the WTRU may need to know power sharing information.

Furthermore, the DL control signaling may need to satisfy two goals. The first goal may be to keep a complexity of the blind decoding (or detection) at the WTRU for each radio resource control (RRC) configured transmission mode, by monitoring the type of DCI formats the WTRU may need for its PDSCH, which may be limited to two types of DCI formats. The second goal may be to minimize the number of RRC configured transmission modes in order to reduce the signaling overhead of the RRC configuration.

Therefore, appropriate designs for dual-layer beamforming and single-port beamforming with dynamic DMRS port signaling would be desirable.

### SUMMARY

A method and apparatus are described for obtaining demodulation reference signal (DMRS) port index information. In one scenario, an evolved Node-B (eNodeB), having a plurality of antenna ports, disables a codeword in a DL control indicator (DCI), uses an unused new data indicator (NDI) bit of the disabled codeword as a DMRS port index information field, and transmits the DCI. A wireless transmit/receive unit (WTRU) receives the DCI from the eNodeB and obtains a DMRS port index from the unused NDI bit of the disabled codeword in the received DCI. In another scenario, a DCI including a disabled codeword and a resource allocation header bit in a DMRS port index information field of the DCI is received by the WTRU. The WTRU re-interprets the resource allocation header bit in the DCI as a DMRS port index.

### BRIEF DESCRIPTION OF THE DRAWINGS

A more detailed understanding may be had from the following description, given by way of example in conjunction with the accompanying drawings wherein:

FIG. 1 shows a mapping of a transport block to a single LTE carrier in an R8 LTE system;

FIG. 2A is a system diagram of an example communications system in which one or more disclosed embodiments may be implemented;

FIG. 2B is a system diagram of an example wireless transmit/receive unit (WTRU) that may be used within the communications system illustrated in FIG. 2A;

FIG. 2C is a system diagram of an example radio access network and an example core network that may be used within the communications system illustrated in FIG. 2A;

FIG. 3 shows a block diagram of an example LTE wireless communication system;

FIG. 4 shows a table representing DCI formats, search spaces and transmission schemes of a PDSCH corresponding to a physical DL control channel (PDCCH) for transmission mode 8;

FIG. 5 shows a table representing information fields (IFs) and number of bits for DCI format 1E, including a transmission scheme indicator IF having two bits;

FIG. 6 shows a table representing transmission scheme indicators for DCI format 1E;

FIG. 7 shows a table representing IFs and number of bits for DCI format 1E;

FIG. 8 shows a table representing transmission scheme indicators, localized virtual resource block (LVRB)/distributed virtual resource block (DVRB) bit re-interpretations and transmission schemes for DCI format 1E;

FIG. 9 shows a table representing IFs and number of bits for DCI format 1E, including a MU-MIMO layer indicator and power sharing IFs, each having a single bit;

FIG. 10 shows a table representing a bit field of a MU-MIMO layer indicator of DCI format 1E;

FIG. 11 shows a table representing a bit field of power sharing information of DCI format 1E/1D;

FIG. 12A shows a table representing IFs and number of bits of SU-MIMO dual layer beamforming for DCI format 2B;

FIG. 12B shows a table representing IFs and number of bits of MU-MIMO beamforming for DCI format 2B;

FIG. 13A shows an alternative table representing IFs and number of bits of SU-MIMO dual layer beamforming for DCI format 2B;

FIG. 13B shows an alternative table representing IFs and number of bits of MU-MIMO beamforming for DCI format 2B;

FIG. 14 shows a table representing DCI formats, search spaces and transmission schemes of a PDSCH corresponding to a PDCCH for transmission mode 8;

FIG. 15 shows a table representing a DMRS port IF;

FIG. 16 shows a table representing a resource allocation header bit re-interpretation of a DCI when one codeword is disabled;

FIG. 17 shows a flow diagram of a procedure for receiving and decoding a PDCCH to determine a transmission scheme;

FIGS. 18 and 19 show flow diagrams of procedures for obtaining DMRS port index information.

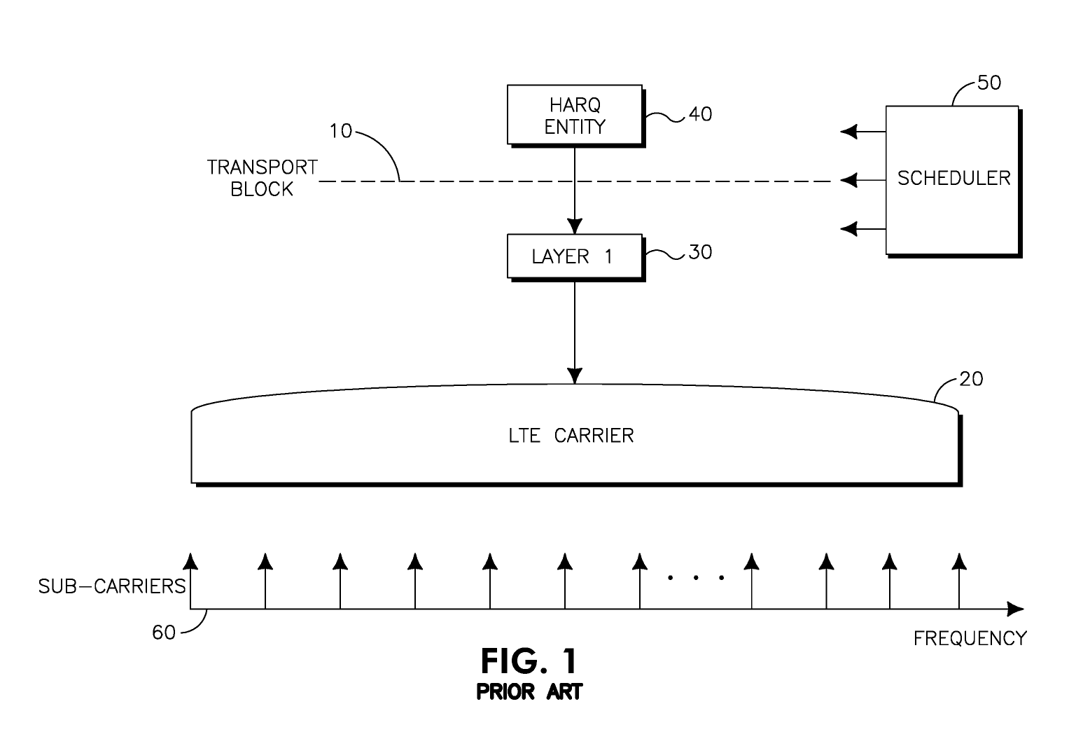

### DETAILED DESCRIPTION

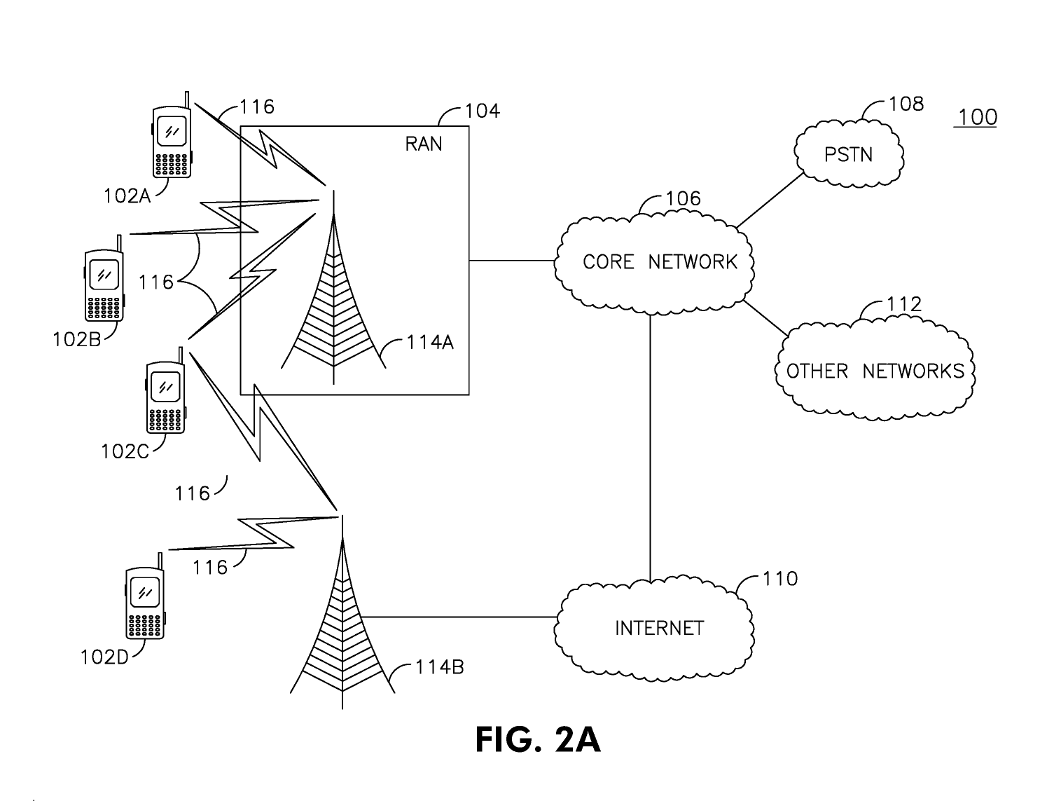

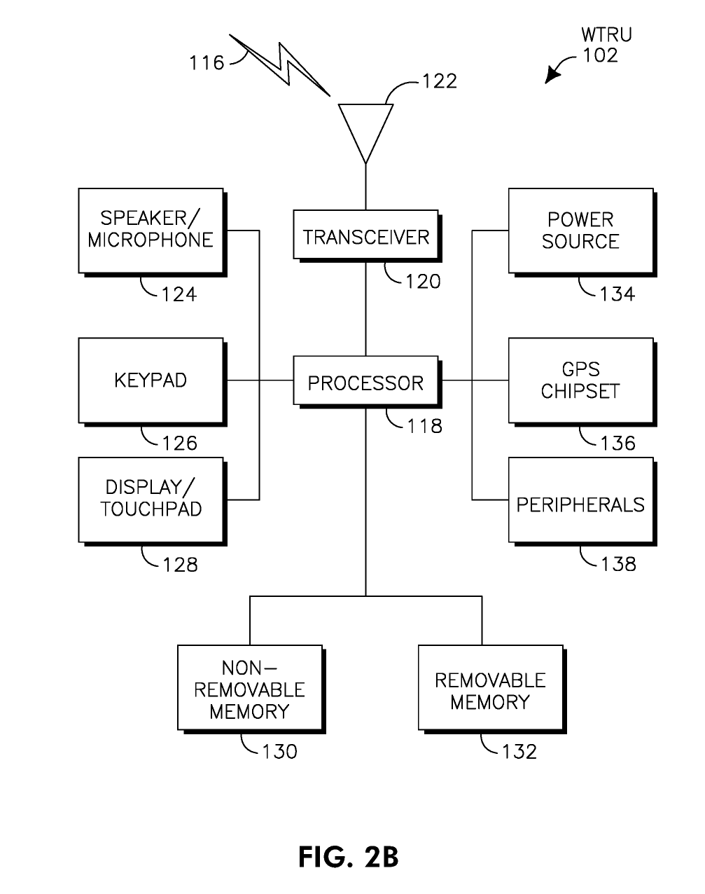

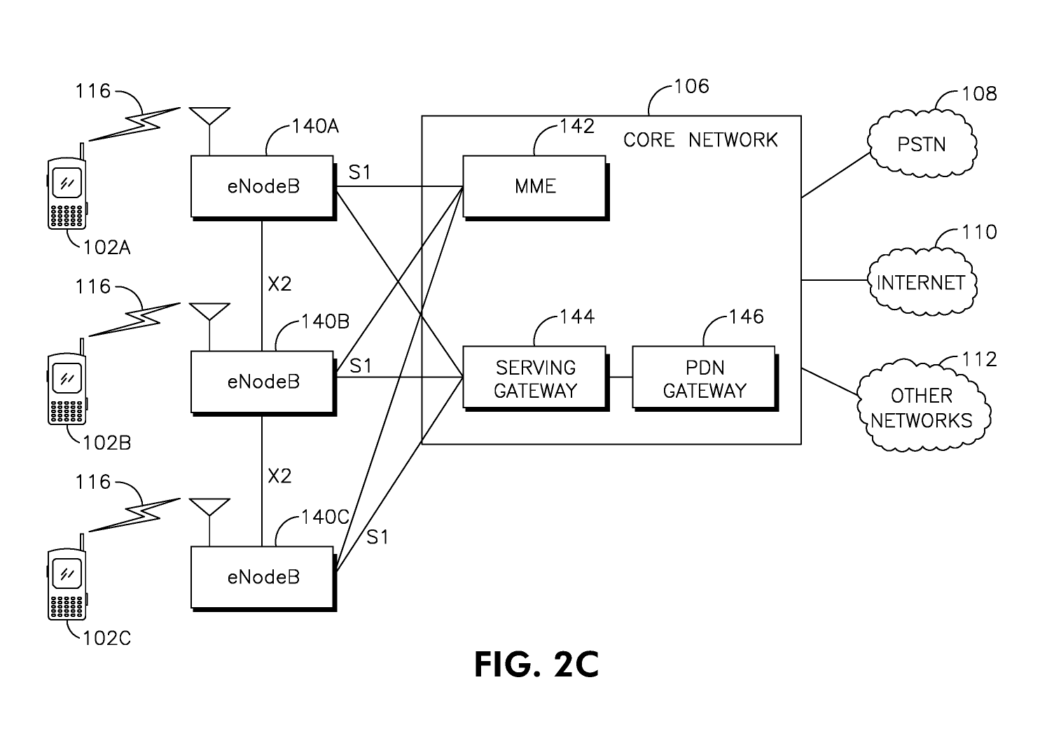

FIG. 2A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications system 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 2A, the communications system 100 may include wireless transmit/receive units (WTRUs) 102A, 102B, 102C, 102D, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102A, 102B, 102C, 102D may be any type of device configured to operate and/or communicate in a wireless environment. By way of example, the WTRUs 102A, 102B, 102C, 102D may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications system 100 may also include a base station 114A and a base station 114B. Each of the base stations 114A, 114B may be any type of device configured to wirelessly interface with at least one of the WTRUs 102A, 102B, 102C, 102D to facilitate access to one or more communication networks, such as the core network 106, the Internet 110, and/or the networks 112. By way of example, the base stations 114A, 114B may be a base transceiver station (BTS), a Node-B, an eNodeB, a Home Node-B, a Home eNodeB, a site controller, an access point (AP), a wireless router, and the like. While the base stations 114A, 114B are each depicted as a single element, it will be appreciated that the base stations 114A, 114B may include any number of interconnected base stations and/or network elements.

The base station 114A may be part of the RAN 104, which may also include other base stations and/or network elements (not shown), such as a base station controller (BSC), a radio network controller (RNC), relay nodes, etc. The base station 114A and/or the base station 114B may be configured to transmit and/or receive wireless signals within a particular geographic region, which may be referred to as a cell (not shown). The cell may further be divided into cell sectors. For example, the cell associated with the base station 114A may be divided into three sectors. Thus, in one embodiment, the base station 114A may include three transceivers, i.e., one for each sector of the cell. In another embodiment, the base station 114A may employ multiple-input multiple output (MIMO) technology and, therefore, may utilize multiple transceivers for each sector of the cell.

The base stations 114A, 114B may communicate with one or more of the WTRUs 102A, 102B, 102C, 102D over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114A in the RAN 104 and the WTRUs 102A, 102B, 102C may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed DL Packet Access (HSDPA) and/or High-Speed Uplink Packet Access (HSUPA).

In another embodiment, the base station 114A and the WTRUs 102A, 102B, 102C may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114A and the WTRUs 102A, 102B, 102C may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114B in FIG. 2A may be a wireless router, Home Node-B, Home eNodeB, or access point, for example, and may utilize any suitable RAT for facilitating wireless connectivity in a localized area, such as a place of business, a home, a vehicle, a campus, and the like. In one embodiment, the base station 114B and the WTRUs 102C, 102D may implement a radio technology such as IEEE 802.11 to establish a wireless local area network (WLAN). In another embodiment, the base station 114B and the WTRUs 102C, 102D may implement a radio technology such as IEEE 802.15 to establish a wireless personal area network (WPAN). In yet another embodiment, the base station 114B and the WTRUs 102C, 102D may utilize a cellular-based RAT (e.g., WCDMA, CDMA2000, GSM, LTE, LTE-A, etc.) to establish a picocell or femtocell. As shown in FIG. 2A, the base station 114B may have a direct connection to the Internet 110. Thus, the base station 114B may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102A, 102B, 102C, 102D. For example, the core network 106 may provide call control, billing services, mobile location-based services, pre-paid calling, Internet connectivity, video distribution, etc., and/or perform high-level security functions, such as user authentication. Although not shown in FIG. 2A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102A, 102B, 102C, 102D to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102A, 102B, 102C, 102D in the communications system 100 may include multi-mode capabilities, i.e., the WTRUs 102A, 102B, 102C, 102D may include multiple transceivers for communicating with different wireless networks over different wireless links. For example, the WTRU 102C shown in FIG. 2A may be configured to communicate with the base station 114A, which may employ a cellular-based radio technology, and with the base station 114B, which may employ an IEEE 802 radio technology.

FIG. 2B is a system diagram of an example WTRU 102. As shown in FIG. 2B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 2B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114A) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, ITV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 2B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114A, 114B) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 2C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNodeBs 140A, 140B, 140C, though it will be appreciated that the RAN 104 may include any number of eNodeBs while remaining consistent with an embodiment. The eNodeBs 140A, 140B, 140C may each include one or more transceivers for communicating with the WTRUs 102A, 102B, 102C over the air interface 116. In one embodiment, the eNodeBs 140A, 140B, 140C may implement MIMO technology. Thus, the eNodeB 140A, for example, may use multiple antennas to transmit wireless signals to, and receive wireless signals from, the WTRU 102a.

Each of the eNodeBs 140A, 140B, 140C may be associated with a particular cell (not shown) and may be configured to handle radio resource management decisions, handover decisions, scheduling of users in the uplink and/or DL, and the like. As shown in FIG. 2C, the eNodeBs 140A, 140B, 140C may communicate with one another over an X2 interface.

The core network 106 shown in FIG. 2C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNodeBs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNodeBs 140A, 140B, 140C in the RAN 104 via the S1 interface. The serving gateway 144 may generally route and forward user data packets to/from the WTRUs 102A, 102B, 102C. The serving gateway 144 may also perform other functions, such as anchoring user planes during inter-eNodeB handovers, triggering paging when DL data is available for the WTRUs 102A, 102B, 102C, managing and storing contexts of the WTRUs 102A, 102B, 102C, and the like.

The serving gateway 144 may also be connected to the PDN gateway 146, which may provide the WTRUs 102A, 102B, 102C with access to packet-switched networks, such as the Internet 110, to facilitate communications between the WTRUs 102A, 102B, 102C and IP-enabled devices.

The core network 106 may facilitate communications with other networks.

For example, the core network 106 may provide the WTRUs 102A, 102B, 102C with access to circuit-switched networks, such as the PSTN 108, to facilitate communications between the WTRUs 102A, 102B, 102C and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102A, 102B, 102C with access to the networks 112, which may include other wired or wireless networks that are owned and/or operated by other service providers.

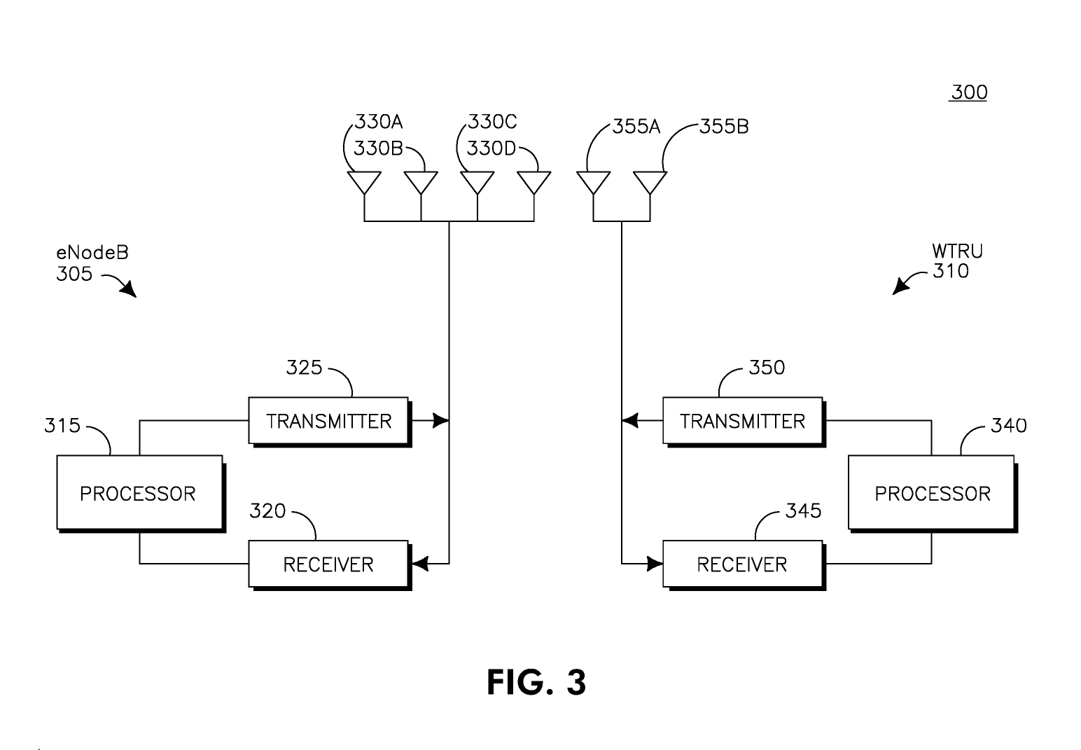

FIG. 3 is an example of a wireless communication system 300 including an eNodeB 305 and a WTRU 310. In addition to the components that may be found in a typical eNodeB, the eNodeB 305 may include a processor 315, a receiver 320, a transmitter 325 and a plurality of dedicated beamforming antenna ports 330A, 330B, 330C and 330D. In addition to the components that may be found in a typical WTRU, the WTRU 310 may include a processor 340, a receiver 345, a transmitter 350 and a plurality of antennas 355A and 355B. The processor 315 in the eNodeB 305 is configured to signal single-port beamforming with DMRS port selection.

In one scenario, the dedicated beamforming antenna ports 330 are DMRS ports dedicated to release 9 (R9) dual-layer beamforming. These dedicated beamforming antenna ports may be configured via RRC signaling in a universal transmission mode, (e.g., mode 8), for single-layer, dual-layer SU-MIMO beamforming, MU-MIMO beamforming, and transmit diversity.

A first type of signaling that may be used is DCI format 1E. The DCI format 1E is associated with single-layer SU-MIMO and MU-MIMO beamforming, (with a predefined, or higher-layer defined, dedicated reference signal (DRS) port), and transmit diversity. The DCI format 1E may be defined by modifying DCI format 1D/1A to indicate three different transmission schemes.

A second type of signaling that may be used is DCI format 2A. The DCI format 2A may be associated with dual-layer beamforming or single-layer beamforming.

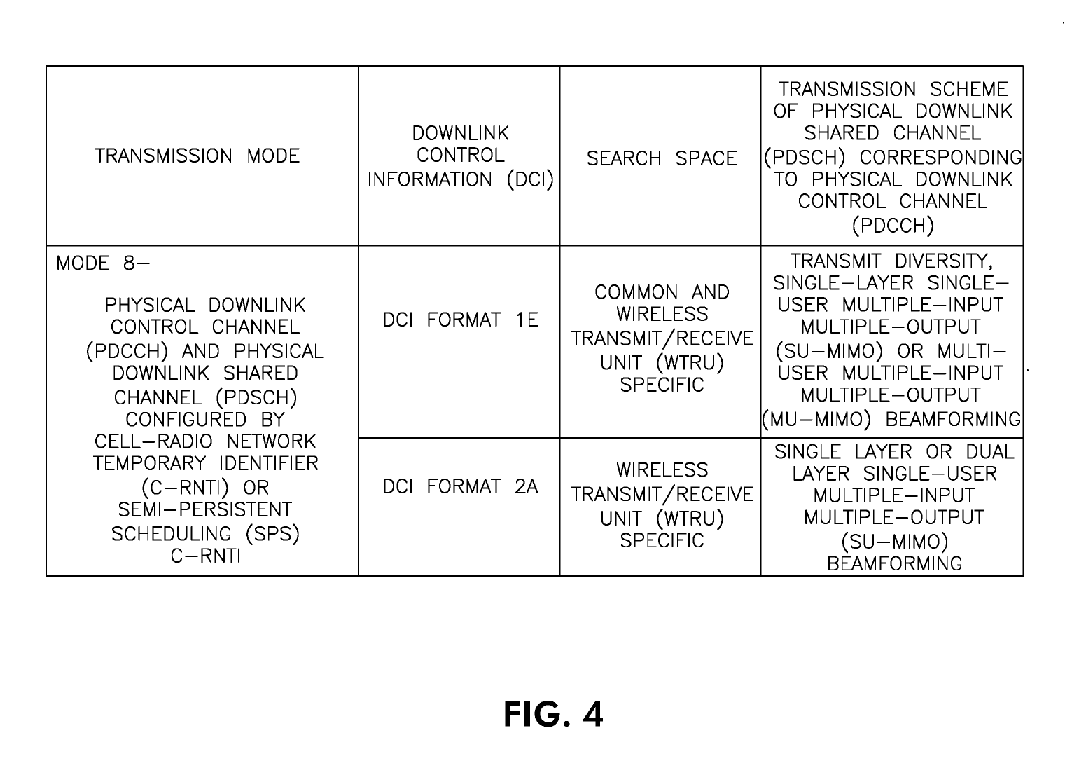

FIG. 4 shows a table representing DCI formats, search spaces and transmission schemes of a PDSCH corresponding to a PDCCH for transmission mode 8. Referring to FIGS. 3 and 4, upon detection of a PDCCH with a DCI format for DL transmission, (such as format 1, 1A, 1B, 1C, 1D, 2, 2A or 2B in R8 LTE), intended for the WTRU 310 in a subframe, the WTRU 310 decodes the corresponding PDSCH in the same subframe with the restriction of the number of transport blocks defined in the higher layers.

In one scenario, the DCI format 1E may use the same number of bits as the DCI format 1D, but the two bits for the transmit precoding matrix indication (TPMI) of the DCI format 1D may be reused as a “transmission scheme indicator”.

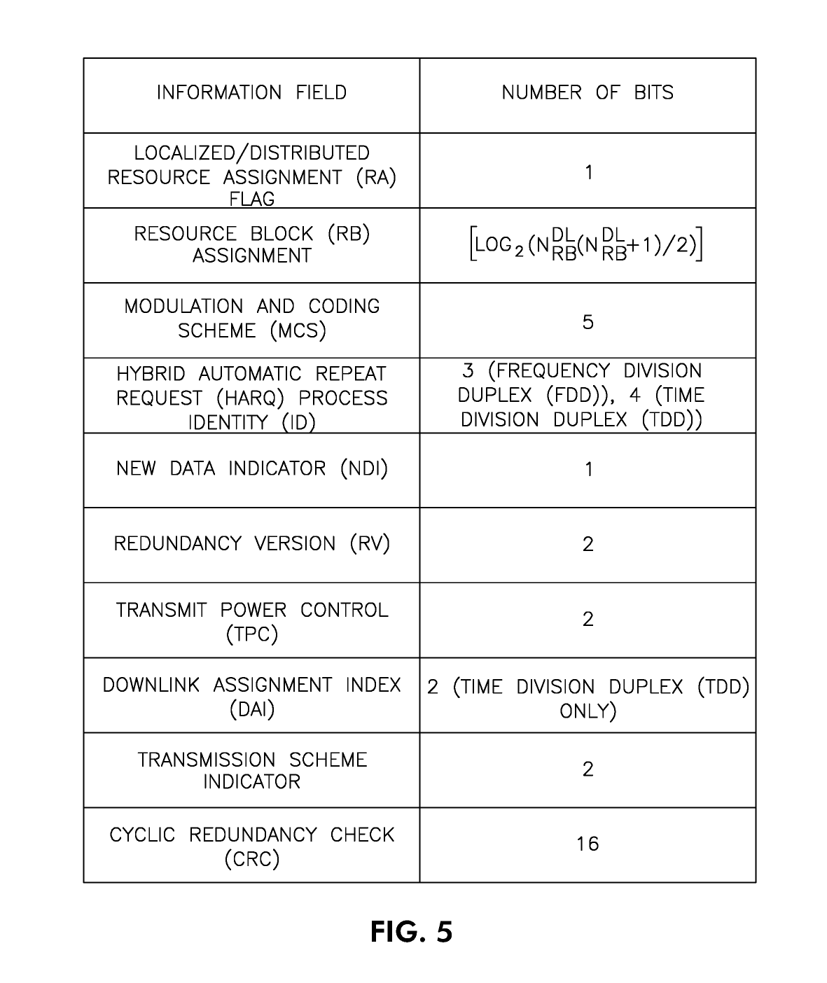

FIG. 5 shows a table representing IFs and number of bits for DCI format 1E, including a transmission scheme indicator IF having two bits. FIG. 5 illustrates the format of the proposed PDCCH format 1E, which also indicates how the WTRU should interpret these fields upon receiving such a PDCCH. In one scenario, the PDCCH format 1E may use one extra bit (used as the transmission scheme indicator) compared to DCI format 1A, and a localized/distributed resource allocation (RA) flag IF (1 bit) may be reused. Alternatively, the DCI format 1E may reuse bits associated with a resource block (RB) assignment IF, a modulation and coding scheme (MCS) IF, a HARQ process identity (ID) IF, an NDI IF, a redundancy version (RV) IF, a transmit power control (TPC) IF, a DL assignment index (DAI) IF, a transmission scheme indicator IF, or a cyclic redundancy check (CRC) IF.

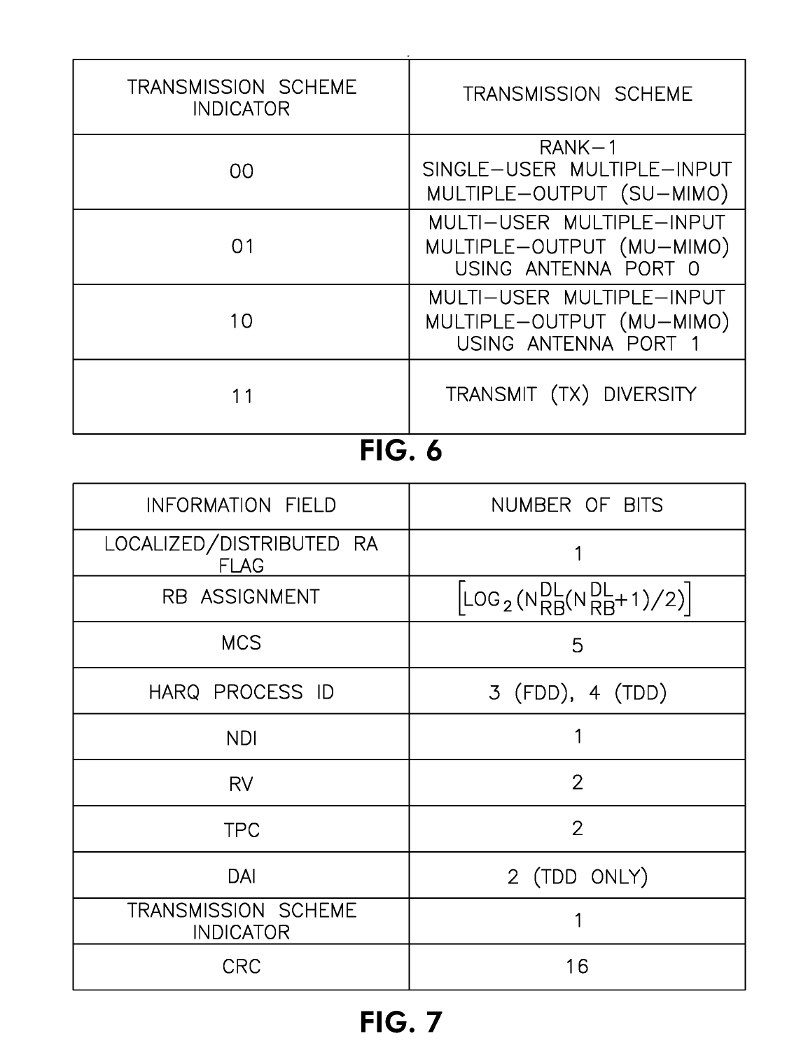

FIG. 6 shows a table representing transmission scheme indicators for DCI format 1E. If the transmission scheme indicator signals one of the MU-MIMO transmission schemes (e.g., “01” or “10”), the MU-MIMO WTRU may derive the power offset information as −3.0 dB, on a condition that equal power distribution between MU-MIMO WTRUs is used. Furthermore, a transmission scheme indicator of “00” may represent rank-1 SU-MIMO, and a transmission scheme indicator of “11” may represent transmit (Tx) diversity.

FIG. 7 shows a table representing IFs and number of bits for DCI format 1E, which is almost identical to the table shown in FIG. 5, except that the transmission scheme indicator only has one bit to reuse instead of two.

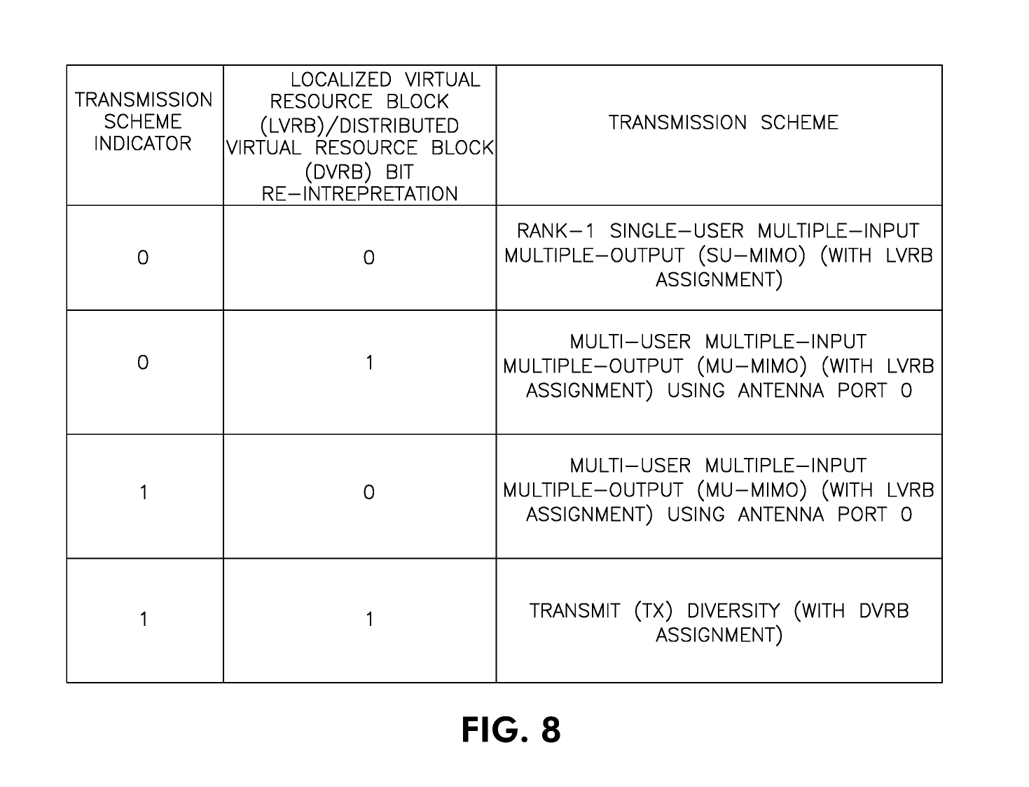

FIG. 8 shows a table representing transmission scheme indicators, localized virtual resource block (LVRB)/distributed virtual resource block (DVRB) bit re-interpretations and transmission schemes for DCI format 1E. For a rank-1 SU-MIMO transmission scheme with an LVRB assignment, the transmission scheme indicator may be set to “0” and the LVRB/DVRB bit re-interpretation may be set to “0”. For a MU-MIMO transmission scheme with an LVRB assignment, the transmission scheme indicator may be set to “0” and the LVRB/DVRB bit re-interpretation may be set to “1”, or the transmission scheme indicator may be set to “1” and the LVRB/DVRB bit re-interpretation may be set to “0”. For a transmit (Tx) diversity transmission scheme with a DVRB assignment, the transmission scheme indicator may be set to “1” and the LVRB/DVRB bit re-interpretation may be set to “1”.

FIGS. 6 and 8 describe the information field of a “transmission scheme indicator” in respective PDCCH formats, and indicate how the WTRU should interpret these fields upon receiving such a PDCCH.

The various scenarios described above may be further extended to LTE-A, where up to eight Tx antennas are used at the eNodeB. Additional bits (one or two) may be used for the transmission scheme indicator information field in the DCI format 1E for LTE-A to indicate antenna ports (up to eight different ones).

A WTRU configured in the new transmission mode, (i.e., a transmission mode in addition to the 7 transmission modes that are already defined in R8 LTE), may monitor DCI format 1E and extended DCI format 2A for its DL assignment.

If a successfully decoded PDCCH is DCI format 1E, the WTRU knows that transmission scheme is transmit diversity, single-layer SU-MIMO or MU-MIMO beamforming from a transmission scheme indicator. The WTRU may use the information in the DCI format 1E, such as transmission scheme, MCS, RB allocation, HARQ information, (HARQ ID, RV and NDI), to decode the data.

If a successfully decoded PDCCH is extended DCI format 2A, the WTRU knows that the transmission scheme is single-layer or dual-layer beamforming from the number of codewords signaled. The WTRU may use the information in DCI format 2A, such as number of codewords, transmission scheme, MCS, RB allocation, HARQ information (HARQ ID, RV and NDI), to decode the data.

In another scenario, a separate transmission mode may be defined and configured (by RRC signaling) for MU-MIMO beamforming. If a non-orthogonal demodulation reference signal (DMRS) is used or time division multiplexing (TDM)/frequency division multiplexing (FDM) based orthogonal DMRS is used, the power sharing information may be signaled to the WTRU when non-equal power distribution between MU-MIMO users is used. A DCI format 1E may use the same number of bits as DCI format 1D, but the two bits for TPMI of DCI format 1D may be reused as an “MU-MIMO layer indicator” and “power sharing information”. The WTRU may need to monitor DCI format 1A to support transmit diversity.

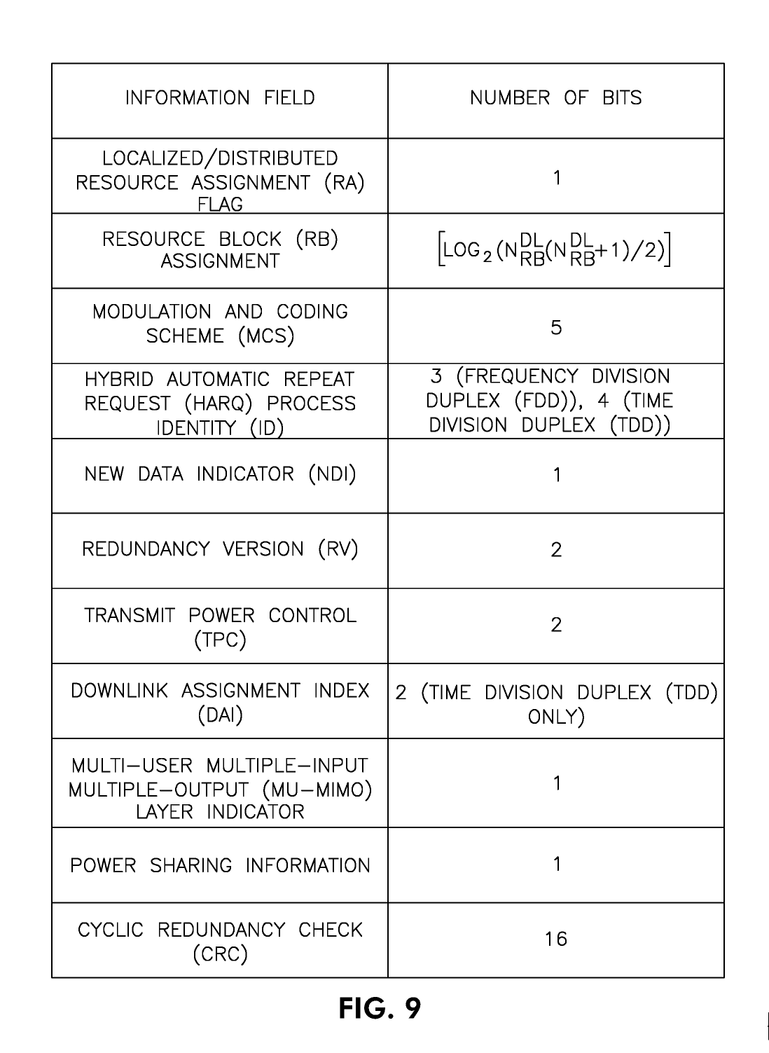

FIG. 9 shows a table representing IFs and number of bits for DCI format 1E, including a MU-MIMO layer indicator and a power sharing IFs, each having a single bit.

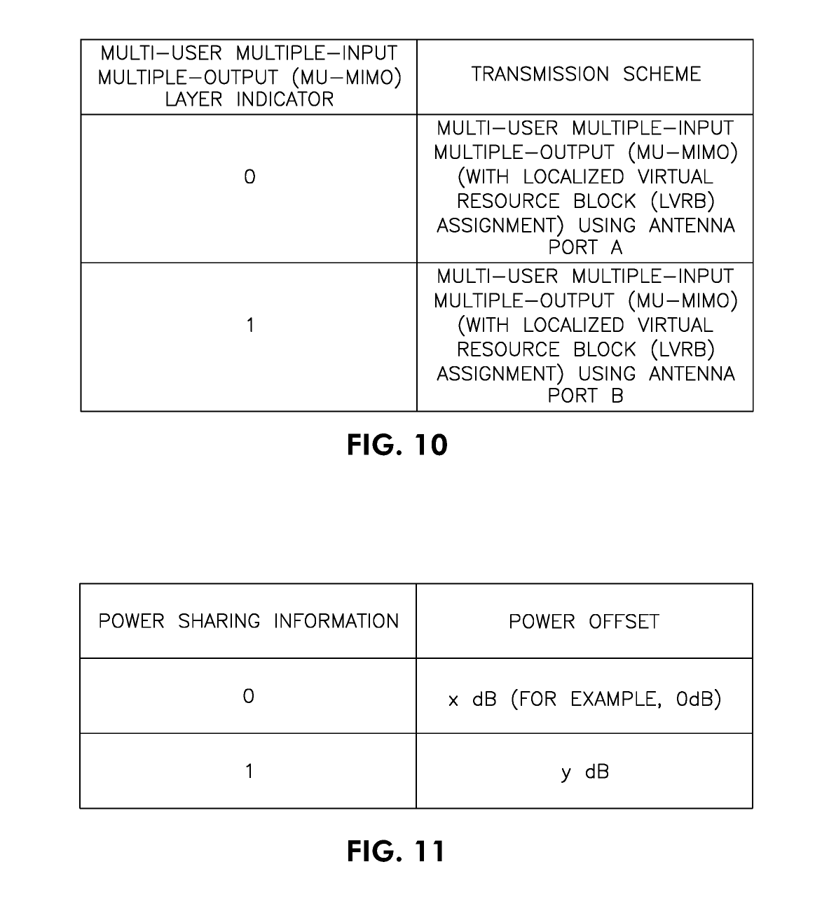

FIG. 10 shows a table representing a bit field of a MU-MIMO layer indicator of DCI format 1E.

FIG. 11 shows a table representing a bit field of power sharing information of DCI format 1E/1D.

The scenarios described above may be further extended to LTE-A where up to 8 Tx antennas are used at the eNodeB. The additional bits (one or two) may be used for MU-MIMO layer indicator and power sharing IFs in the DCI format 1E for LTE-A to indicate antenna ports (up to 8 different ones) and power offset levels (up to 8 different ones) respectively.

A WTRU configured in the new transmission mode, (i.e., a transmission mode in addition to the 7 transmission modes that are already defined in R8 LTE), may monitor the DCI format 1E and the DCI format 1A for its DL assignment. If a successfully decoded PDCCH is DCI format 1A, the WTRU knows that the transmission scheme is transmit diversity. The WTRU may use the information in DCI format 1A, such as transmission scheme, MCS, RB allocation, HARQ information, (HARQ ID, RV and NDI), to decode the data. If a successfully decoded PDCCH is DCI format 1E, the WTRU knows that the transmission scheme is MU-MIMO beamforming. The WTRU may use the information in DCI format 1E, such as transmission scheme, MCS, RB allocation, HARQ information (HARQ ID, RV and NDI), antenna port and power sharing information, to decode the data.

In another scenario, a transmission mode may be defined and configured (by RRC signaling) for MU-MIMO and SU-MIMO dual-layer beamforming. A DCI format 2B may be modified based on the DCI format 2A, (precoding information may not be used). A one bit transmission scheme indicator may be used to indicate SU or MU beamforming. The WTRU may also need to monitor the DCI format 1A to support transmit diversity.

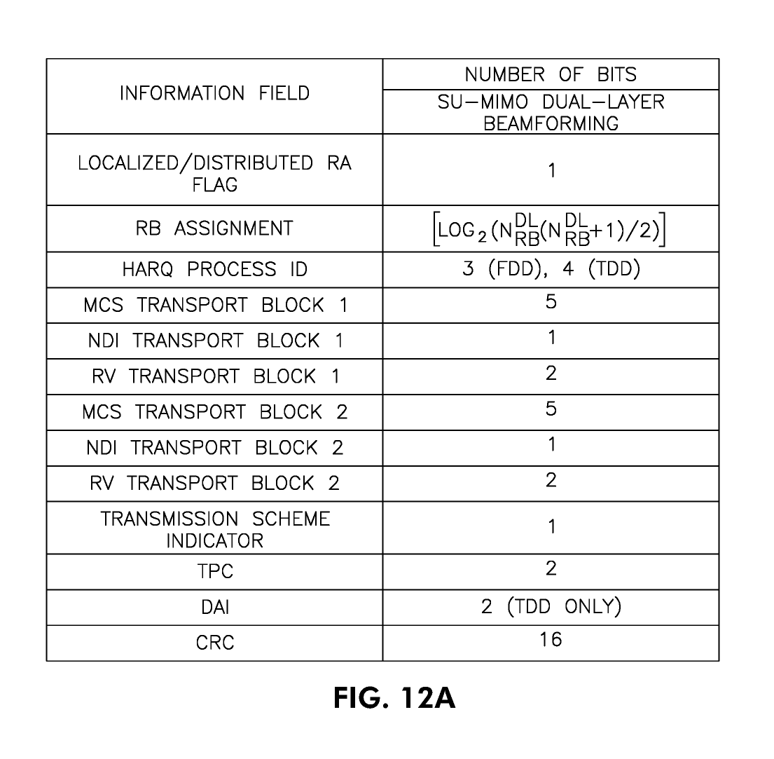

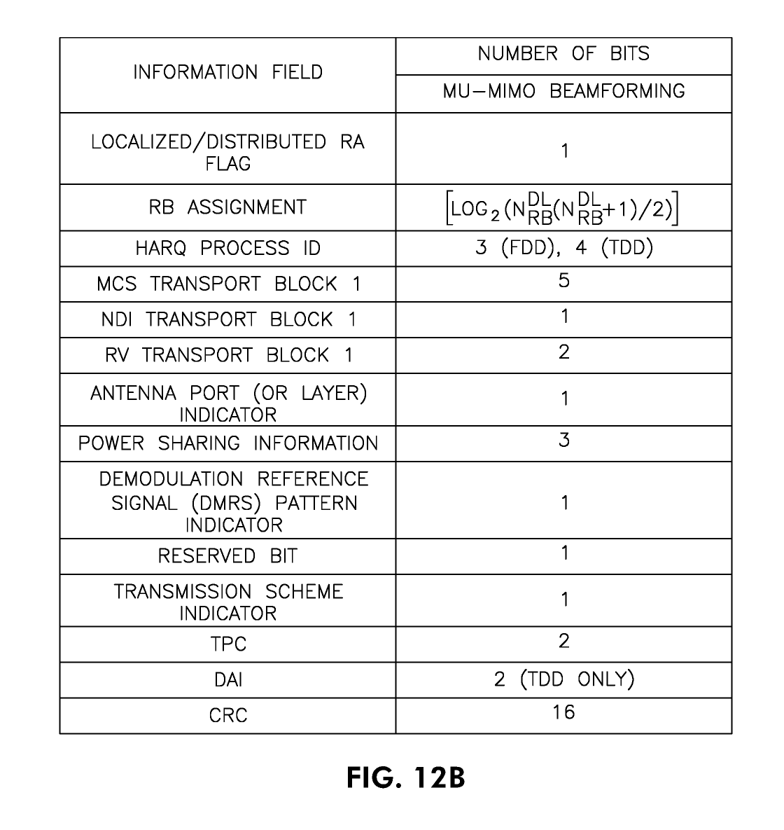

FIG. 12A shows a table representing IFs and number of bits of SU-MIMO dual layer beamforming for DCI format 2B.

FIG. 12B shows a table representing IFs and number of bits of MU-MIMO beamforming for DCI format 2B.

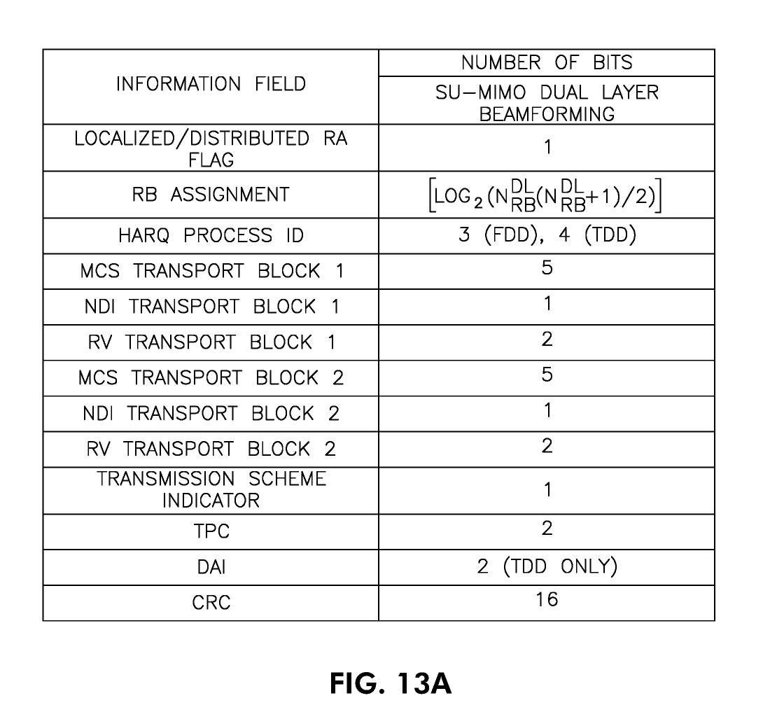

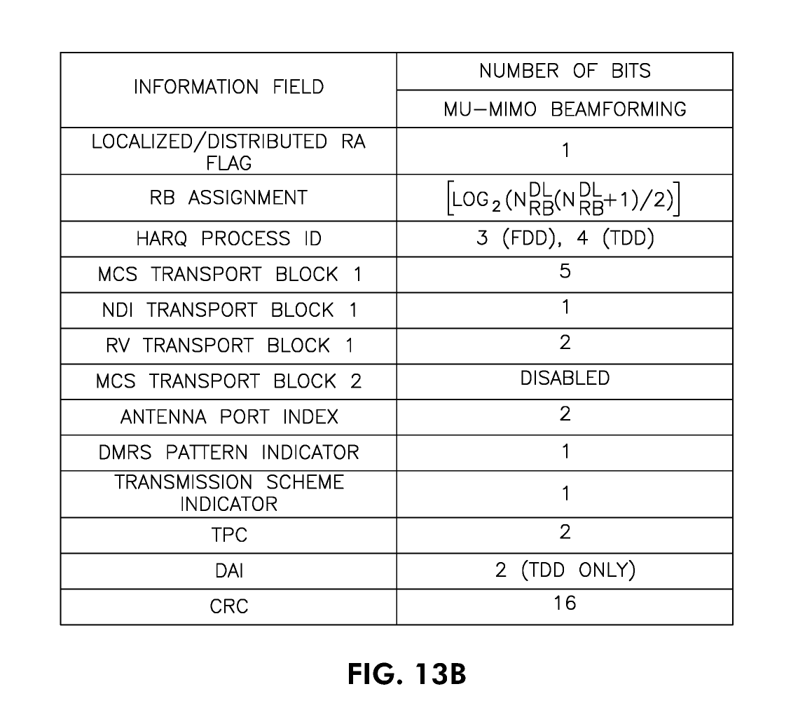

FIG. 13A shows an alternative table representing IFs and number of bits of SU-MIMO dual layer beamforming for DCI format 2B.

FIG. 13B shows an alternative table representing IFs and number of bits of MU-MIMO beamforming for DCI format 2B.

A WTRU configured in the new mode, (i.e., a transmission mode in addition to the 7 transmission modes that are already defined in R8 LTE), may monitor the DCI format 1E and extended DCI format 2A for its DL assignment.

If a successfully decoded PDCCH is DCI format 1A, the WTRU knows that transmission scheme is transmit diversity. The WTRU may use the information in DCI format 1A, such as transmission scheme, MCS, RB allocation, HARQ information, (HARQ ID, RV and NDI), to decode the data.

If a successfully decoded PDCCH is extended format 2B, the WTRU knows that the transmission scheme is SU-MIMO or MU-MIMO beamforming from the transmission scheme indicator bit. For SU-MIMO beamforming, the WTRU further knows it is single-layer or dual-layer beamforming from the number of codewords signaled. The WTRU may use the information in the DCI format 2B, such as number of codewords, transmission scheme, MCS, RB allocation, HARQ information (HARQ ID, RV and NDI), antenna port, power sharing information and DMRS pattern, to decode the data.

In another scenario, when there is no explicit MU-MIMO signaling support for MU-MIMO, dual-layer SU-MIMO, single-port beamforming and transmit diversity may be supported. When single-port transmission is used, one of the antenna ports may be dynamically selected for transmission or configured. To simplify the following discussion, “single-port beamforming” may be defined to represent SU/MU rank-1 transmission without distinguishing between SU and MU.

In one scenario, the DCI format 1A may be used to signal transmit diversity, and a DCI based on format 2A may be used to signal dual-layer beamforming and/or single-port beamforming with antenna DMRS port selection. Thus, this extended DCI format 2A may have the same information fields as LTE R8 DCI format 2A, but some fields may have a different interpretation, or only a subset of information fields of LTE R8 DCI format 2A is used.

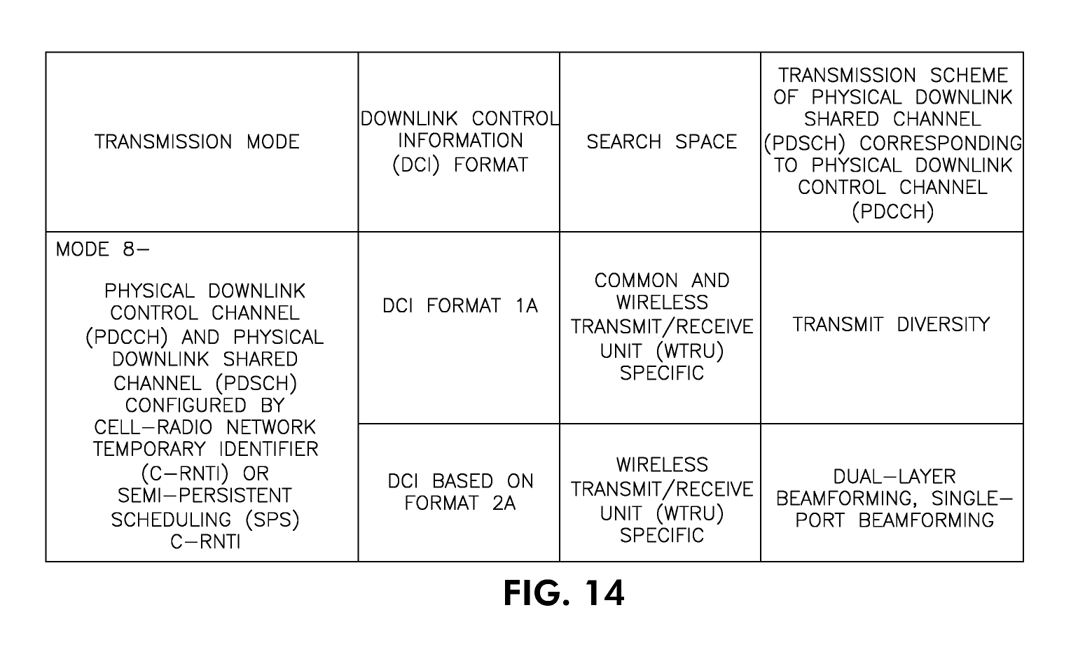

FIG. 14 shows a table representing DCI formats, search spaces and transmission schemes of a PDSCH corresponding to a PDCCH for transmission mode 8.

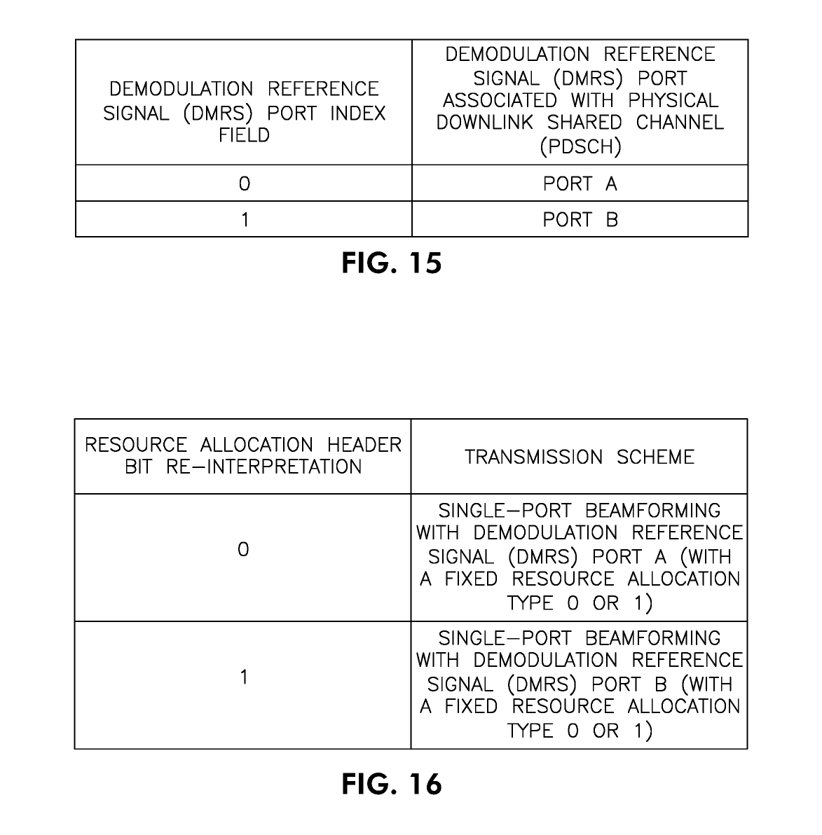

Single-port beamforming with a dynamic DMRS port index may be signaled by disabling a codeword in DCI based on format 2A. Signaling DMRS port index for single-port beamforming via a DCI based on format 2A may be performed using two procedures. In a first procedure, the unused NDI bit of the disabled codeword in the extended DCI format 2A may be used as a DMRS port index field, as shown in FIG. 15. In a second procedure, a resource allocation header (resource allocation type 0/type 1) bit may be re-interpreted. The resource allocation header is part of the DCI/PDCCH, and therefore it may be used or reused as other parts of the DCI to carry information and to obtain a DMRS port index. For example, the resource allocation header (resource allocation type 0/type 1) bit in DCI format 2A may be re-interpreted when one codeword is disabled.

FIG. 16 shows a table representing a resource allocation header bit re-interpretation of a DCI when one codeword is disabled. The resource allocation type for single-port beamforming may be fixed to be type 0 or type 1.

CRC masking may be applied to the DCI based format 2A. For example, one bit may be provided via CRC masking, as in the case of DCI format 0 for uplink (UL) antenna selection, which may correspond to reduced CRC protection length and reduced number of C-RNTIs. The DMRS index may be indicated in an implicit manner via the position of the PDCCH in the search space. For example, one position may be set to be associated with DMRS port A, and another position may be set to be associated with DMRS port B. In addition, a bit may be added to the DCI format 1A payload, or in some cases, a “zero padding bit” in format 2A may be reused.

A WTRU being configured in the new mode, (i.e., a transmission mode in addition to the 7 transmission modes that are already defined in R8 LTE), will monitor DCI format 1A and extended DCI format 2A for its DL assignment. If a successfully decoded PDCCH is DCI format 1A, the WTRU knows that the transmission scheme is transmit diversity. The WTRU will use the information in DCI format 1A, such as transmission scheme, MCS, RB allocation, HARQ information (HARQ ID, RV and NDI), to decode the data. If a successfully decoded PDCCH is extended DCI format 2A, the WTRU knows that transmission scheme is single-port or dual-layer beamforming from the number of codewords signaled. The WTRU will use the information in extended DCI format 2A, such as number of codewords, transmission scheme, MCS, RB allocation, HARQ information (HARQ ID, RV and NDI) and DMRS port, to decode the data. If one codeword is disabled in the received extended DCI format 2A, then the WTRU may determine that the PDSCH is based on single-port beamforming, and will obtain the DMRS port index from the unused NDI bit of the disabled codeword. The WTRU may perform channel estimation on the assigned DMRS port to obtain its effective channel, (channel multiplied by precoding matrix/vector), and perform blind detection of DMRS on the other DMRS port (which is not assigned to the WTRU). If the WTRU detects that there is transmission of a DMRS on the DMRS port not assigned to it, the WTRU may regard that it is operating in MU-MIMO, and use the blindly detected effective channel(s) on the other DMRS port to suppress interference from co-scheduled MU-MIMO user(s) on the same (physical) resource blocks.

Referring again to FIG. 3, the eNodeB 305 includes a plurality of antenna ports 330. The processor 315 in the eNodeB 305 may be configured to disable a codeword in a DCI, and use an unused NDI bit of the disabled codeword as a DMRS port IF. The receiver 345 in the WTRU 310 may be configured to receive a PDCCH. The processor 340 in the WTRU 310 may be configured to decode the PDCCH to determine a DCI format of the PDCCH and determine a transmission scheme based on the DCI format. The receiver 345 in the WTRU 310 may be configured to obtain a DMRS port index based on the DMRS port IF.

The DCI may be based on DCI format 2A, and the transmission scheme may be single-port beamforming with DMRS port selection.

The processor 315 in the eNodeB 305 may be configured to reuse a resource allocation header bit of a DCI as a DMRS port index IF, and set a resource allocation type for single-port beamforming.

The WTRU 310 may decode the PDCCH to obtain a transmission scheme indicator which may include a power sharing IF or a MU-MIMO layer indicator IF.

The DCI format may include at least one of a localized/distributed RA flag IF, an RB assignment IF, an MCS IF, a HARQ process ID, an NDI IF, a RV IF, a TPC IF, a DAI IF, a transmission scheme indicator IF, a CRC IF, a DMRS pattern indicator IF, and a DMRS port index field.

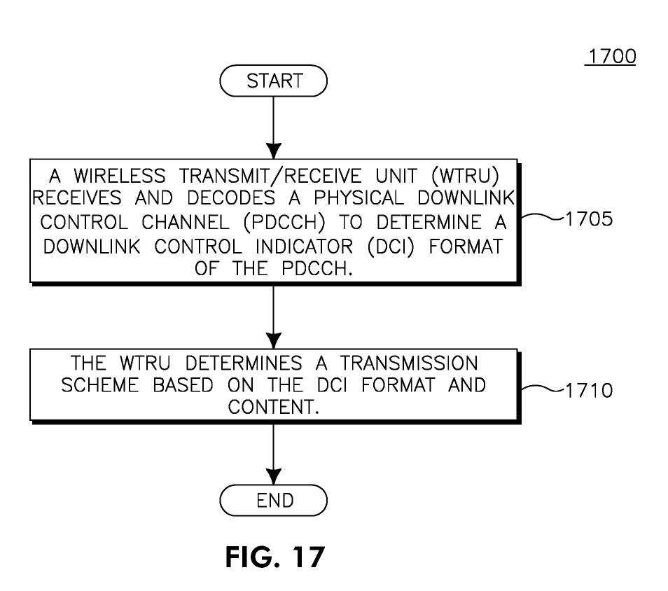

FIG. 17 shows a flow diagram of a procedure 1700 for receiving and decoding a PDCCH to determine a transmission scheme. A WTRU receives and decodes a PDCCH to determine a DCI format of the PDCCH (1705). The WTRU determines a transmission scheme based on the DCI format and content (1710).

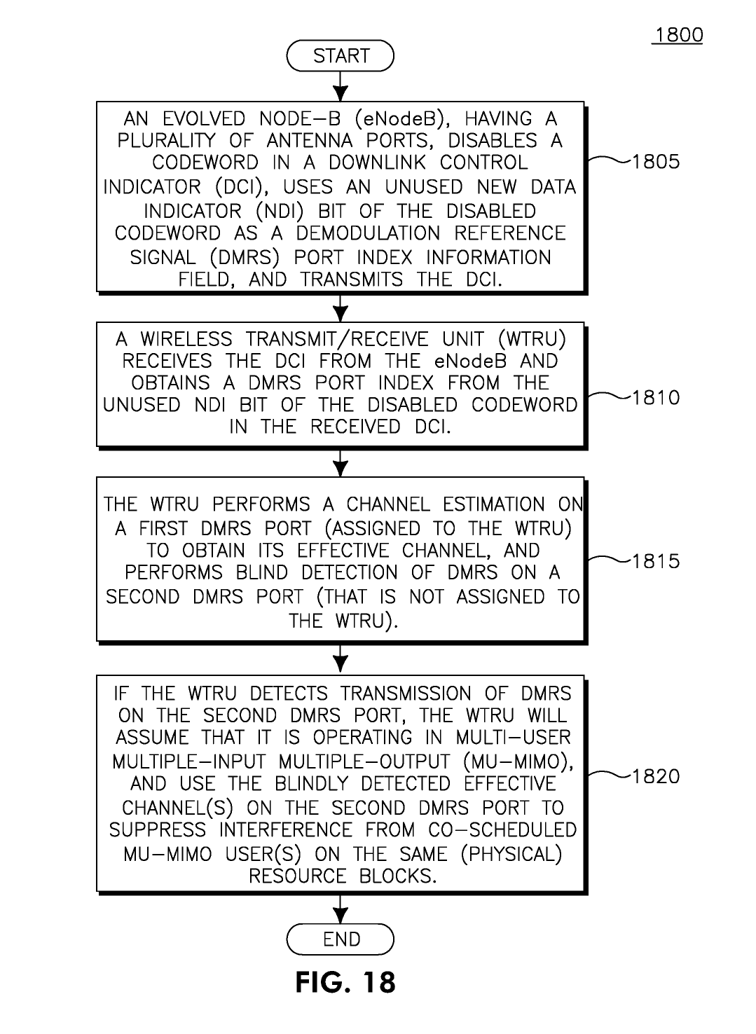

FIG. 18 shows a flow diagram of a procedure 1800 for obtaining DMRS port index information. An eNodeB, having a plurality of antenna ports, disables a codeword in a DCI, uses an unused NDI bit of the disabled codeword as a DMRS port index information field, and transmits the DCI (1805). A WTRU receives the DCI from the eNodeB and obtains a DMRS port index from the unused NDI bit of the disabled codeword in the received DCI (1810). The WTRU then performs a channel estimation on a first DMRS port (assigned to the WTRU) to obtain its effective channel (channel multiplied by the precoding matrix/vector used for the PDSCH of the WTRU), and performs blind detection of DMRS on a second DMRS port (that is not assigned to the WTRU), (1815). If the WTRU detects that there is transmission of DMRS on the second DMRS port, the WTRU will assume that it is operating in MU-MIMO, and use the blindly detected effective channel(s) on the second DMRS port to suppress interference from the co-scheduled MU-MIMO user(s) on the same (physical) resource blocks (1820).

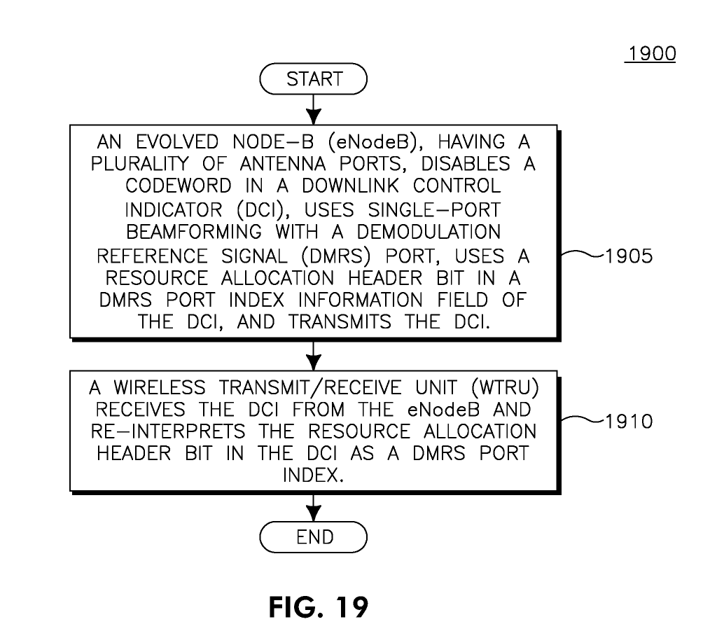

FIG. 19 shows a flow diagram of a procedure 1900 for obtaining DMRS port index information. An eNodeB, having a plurality of antenna ports, disables a codeword in a DCI, uses single-port beamforming with a DMRS port, uses a resource allocation header bit in a DMRS port index information field of the DCI, and transmits the DCI (1905). A WTRU receives the DCI from the eNodeB and re-interprets the resource allocation header bit in the DCI as a DMRS port index (1910). Thus, a bit field that was originally used to signal a first bit, is now reused to signal a second bit in a new transmission mode. The DRMS port has a fixed resource allocation type designated by the re-interpreted resource allocation header bit.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-20. (canceled)

21. A method comprising:
receiving, by a wireless transmit/receive unit (WTRU), downlink control information (DCI) including a new data indicator (NDI), wherein the NDI has a value indicating an antenna port for single-port transmission; and
in response to receiving the DCI, receiving a single-port transmission associated with the indicated antenna port.

22. The method of claim 21 wherein the NDI is associated with a disabled codeword and the DCI includes a second NDI.

23. The method of claim 21 wherein the NDI is a single bit.

24. The method of claim 21 wherein the DCI is a DCI format 2B.

25. The method of claim 21 wherein the DCI is received over a physical downlink control channel (PDCCH).

26. The method of claim 21 wherein the DCI includes a resource block (RB) assignment information field (IF), a hybrid automatic repeat request (HARQ) process identity (ID) IF, a transmit power control (TPC) IF and, for each of a plurality of transport blocks, a modulation and coding scheme (MCS), an NDI and a redundancy version (RV).

27. A wireless transmit/receive unit (WTRU) comprising:
a receiver and associated processor configured to receive downlink control information (DCI) including a new data indicator (NDI), wherein the NDI has a value indicating an antenna port for single-port transmission; and
the receiver and associated processor configured to receive a single-port transmission associated with the indicated antenna port in response to receiving the DCI.

28. The WTRU of claim 27 wherein the wherein the NDI is associated with a disabled codeword and the DCI includes a second NDI.

29. The WTRU of claim 27 wherein the NDI is a single bit.

30. The WTRU of claim 27 wherein the DCI is a DCI format 2B.

31. The WTRU of claim 27 wherein the receiver and associated processor are configured to receive the DCI over a physical downlink control channel (PDCCH).

32. The WTRU of claim 27 wherein the DCI includes a resource block (RB) assignment information field (IF), a hybrid automatic repeat request (HARQ) process identity (ID) IF, a transmit power control (TPC) IF and, for each of a plurality of transport blocks, a modulation and coding scheme (MCS), an NDI and a redundancy version (RV).

33. An evolved Node-B (eNodeB) comprising:
a transmitter and associated processor configured to transmit downlink control information (DCI) including a new data indicator (NDI), wherein the NDI has a value indicating an antenna port for single-port transmission; and
the transmitter and associated processor configured to transmit a single-port transmission using the indicated antenna port.

34. The eNodeB of claim 33 wherein the NDI is associated with a disabled codeword and the DCI includes a second NDI.

35. The eNodeB of claim 33 wherein the NDI is a single bit.

36. The eNodeB of claim 33 wherein the DCI is a DCI format 2B.

37. The eNodeB of claim 33 wherein the transmitter and associated processor are configured to transmit the DCI over a physical downlink control channel (PDCCH).

38. The eNodeB of claim 33 wherein the DCI includes a resource block (RB) assignment information field (IF), a hybrid automatic repeat request (HARQ) process identity (ID) IF, a transmit power control (TPC) IF and, for each of a plurality of transport blocks, a modulation and coding scheme (MCS), an NDI and a redundancy version (RV).
